(19) United States
(12) Patent Application Publication
(10) Pub. No.: US 2023/0280680 A1
(43) Pub. Date: Sep. 7, 2023

(54) INTERMEDIATE TRANSFER BELT, TRANSFER DEVICE, AND IMAGE FORMING APPARATUS

(71) Applicant: FUJIFILM Business Innovation Corp., Tokyo (JP)

(72) Inventors: Hiroaki TANAKA, Kanagawa (JP); Masato FURUKAWA, Kanagawa (JP); Shigeru FUKUDA, Kanagawa (JP); Daisuke TANEMURA, Kanagawa (JP); Masato ONO, Kanagawa (JP); Masayuki SEKO, Kanagawa (JP); Yosuke KUBO, Kanagawa (JP); Iori NISHIMURA, Kanagawa (JP)

(73) Assignee: FUJIFILM Business Innovation Corp., Tokyo (JP)

(21) Appl. No.: 18/161,852

(22) Filed: Jan. 30, 2023

(30) Foreign Application Priority Data
Mar. 2, 2022 (JP) 2022-031978

(51) Int. Cl. G03G 15/16

(52) U.S. Cl. CPC G03G 15/161

(57) ABSTRACT

An intermediate transfer belt includes, on an outer peripheral surface, a coating body of a solid lubricant selected from an organic layered compound or an organic-inorganic composite layered compound.

### CROSS-REFERENCE TO RELATED APPLICATIONS

This application is based on and claims priority under 35 USC 119 from Japanese Patent Application No. 2022-031978 filed Mar. 2, 2022.

### BACKGROUND

### (i) Technical Field

The present invention relates to an intermediate transfer belt, a transfer device, and an image forming apparatus.

### (ii) Related Art

In image forming apparatuses (e.g., copying machines, facsimiles, and printers) using electrophotography, a toner image formed on the surface of an image holding body is transferred onto a surface of a recording medium and fixed on the recording medium to form an image. For example, an intermediate transfer belt is used to transfer the toner image onto the recording medium.

For example, JP2003-076088A discloses “a flame-retardant seamless belt molded by using a thermoplastic composition as a main component, the belt having a volume-specific resistance value of 1.0×10⁴ Ω·cm or more and 1.0×10¹² Ω·cm or less and containing 15 wt % or more and 40 wt % or less of melamine cyanurate relative to a total weight”.

JP2013-545123A discloses “an endless belt including a mold release coating layer containing an inorganic layered compound such as polysilazane, silica, polysiloxane, or a derivative thereof”.

JP2012-042656A discloses “an intermediate transfer belt that is to be used in an image forming apparatus equipped with a lubricant application mechanism, wherein a surface of the intermediate transfer belt as a toner contact surface has a surface roughness with a maximum height roughness (Ry) of 0.1 μm<Ry<20 μm and an arithmetic average roughness (Ra) of 0.05 μm<Ra<3 the toner contact surface having irregularities of more than 0.05 μm and less than 4 μm in width.

JP2012-042656A discloses a fatty acid metal salt as a lubricant.

### SUMMARY

Aspects of non-limiting embodiments of the present disclosure relate to an intermediate transfer belt having an improved transfer maintenance property and a cleaning maintenance property as compared with an intermediate transfer belt including, on an outer peripheral surface, a coating body of a solid lubricant selected from a fatty acid metal salt or an inorganic layered compound.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an intermediate transfer belt including, on an outer peripheral surface, a coating body of a solid lubricant selected from an organic layered compound or an organic-inorganic composite layered compound.

### BRIEF DESCRIPTION OF THE DRAWINGS

FIG. 1 is a schematic configuration diagram illustrating an example of an image forming apparatus according to an exemplary embodiment.

FIG. 2 is a schematic configuration diagram illustrating a periphery of a secondary transfer unit in another example of the image forming apparatus according to the exemplary embodiment.

### DETAILED DESCRIPTION

Hereinafter, exemplary embodiments of the present invention will be described. The following descriptions and examples are provided to illustrate the exemplary embodiments and are not intended to limit the scope of the exemplary embodiments.

An upper limit or a lower limit described in one numerical range of numerical ranges described stepwise in the embodiments may be replaced with an upper limit or a lower limit in other stepwise numerical ranges described stepwise. In addition, the upper limit value or the lower limit value of any numerical range described in the present embodiments may be replaced with a value described in examples.

In the exemplary embodiments, a term “step” includes not only an independent step but also a step that cannot be clearly distinguished from other steps as log as the intended purpose of the step is achieved.

When an exemplary embodiment is described with reference to the drawings in the exemplary embodiments, the configuration of the exemplary embodiment is not limited to the configuration illustrated in the drawings. Further, a sizes of a members in each drawing is conceptual, and a relative relationship in size between members is not limited to thereto.

In the exemplary embodiments, each component may contain a plurality of kinds of of corresponding substances. In the exemplary embodiments, an amount of each component in a composition refers to, when there are a plurality of kinds of substances corresponding to each component in the composition, the total amount of the plurality of kinds of substances present in the composition unless otherwise specified.

[Intermediate Transfer Belt]

An intermediate transfer belt according to an exemplary embodiment is an intermediate transfer belt including, on an outer peripheral surface, a coating body of a solid lubricant selected from an organic layered compound or an organic-inorganic composite layered compound.

The intermediate transfer belt according to the exemplary embodiment has an improved transfer maintenance property and cleaning maintenance property because of the above-described configuration. Although the exact reason therefor is not clear, the following may be presumed.

There is a conventionally known intermediate transfer belt including a coating body of a solid lubricant selected from a fatty acid metal salt or an inorganic layered compound on its outer peripheral surface to improve the transfer property of the intermediate transfer belt.

However, the fatty acid metal salt, having a C—C bond which is a single bond in its structure, oxidatively deteriorates when receiving charges that are released in second transfer or the like. Thus, after oxidative deterioration, in the fatty acid salt its viscosity increase, degrades its lubricity (that is, mold releasability) is degraded, and degrades the transfer property is degraded over time.

On the other hand, the inorganic layered compound, having high hardness, causes the outer peripheral surface of the intermediate transfer belt to have friction marks when the compound rubs on a contact member (e.g., a cleaning member or a secondary transfer member) that is in contact with the intermediate transfer belt, and degrades the cleaning property over time.

In contrast, the organic layered compound or organic-inorganic composite layered compound, having organic components, has low hardness and is soft as compared with inorganic layered compounds. Thus, friction marks are unlikely to be formed on the outer peripheral surface of the intermediate transfer belt when the compound rubs on a contact member (e.g., a cleaning member or a secondary transfer member) that is in contact with the intermediate transfer belt. Therefore, the cleaning maintenance property is improved.

Further, the organic layered compound or organic-inorganic composite layered compound has cleavability. Thus, even when the organic layered compound or organic-inorganic composite layered compound receives charges that are released in secondary transfer or the like and oxidatively deteriorates, the oxidatively deteriorated surface is cleaved, and a compound that is not oxidatively deteriorated appears on the surface. Further, the cleavage improves the mold releasability or forms fine irregularities, thereby reducing the van der Waals force between toner and the intermediate transfer belt. The lubricity (that is, mold releasability) is maintained.

From the above, it is presumed that the intermediate transfer belt according to the exemplary embodiment has an improved transfer maintenance property and cleaning maintenance property because of the above-described configuration.

Hereinafter, the intermediate transfer belt according to the exemplary embodiment will be described in detail.

(Coating Body)

The coating body includes a solid lubricant selected from an organic layered compound or an organic-inorganic composite layered compound.

—Solid Lubricant—

The organic layered compound is a compound in which planar molecules of an organic substance are stacked in layers and is a compound having cleavability.

Examples of the organic layered compound include melamine cyanurate.

Among the examples, melamine cyanurate, which has high oxidation resistance and low hardness and can improve the transfer maintenance property and cleaning maintenance property, is preferable as the organic layered compound.

The organic-inorganic layered compound is a compound in which planar molecules of an organic-inorganic composite are stacked in layers and is a compound having cleavability.

Examples of the organic-inorganic layered compound include a phthalocyanine compound.

Among the examples, a phthalocyanine compound, having high oxidation resistance and low hardness, can improve the transfer maintenance property and cleaning maintenance property, which has high oxidation resistance and low hardness and can improve the transfer maintenance property, is preferable as the organic-inorganic layered compound.

Examples of the phthalocyanine compound include a metal-free phthalocyanine compound, a copper phthalocyanine compound, an iron phthalocyanine compound, a zinc phthalocyanine compound, a nickel phthalocyanine compound, a vanadyl phthalocyanine compound, an indium chloride phthalocyanine compound, a tin phthalocyanine compound, and a naphthalocyanine compound. The phthalocyanine compound may have a substituent (e.g., an alkyl ether group, an alkyl thioether group, an aryl ether group, an aryl thioether group, an amide group, an amino group, an alkyl ester group, an aryl ester group, a chlorine atom, or a fluorine atom) in an aromatic ring. When there are two or more substituents in the aromatic ring, they may be the same or different, and the substituents may be bonded to each other to form a ring.

As the solid lubricant, an organic layered compound is preferable, and melamine cyanurate is more preferable.

The organic layered compound is inferior to the organic-inorganic layered compound in oxidation resistance, but it has a high cleavability and improves the transfer maintenance property. Further, the organic layered compound has a lower hardness than the organic-inorganic layered compound, and it improves the cleaning maintenance property.

In particular, since melamine cyanurate is an organic salt composed of melamine and cyanuric acid, it has a six membered ring planar structure, and is a compound having a stable chemical structure in which melamine and cyanuric acid form hydrogen bonds at three sites. Thus, melamine cyanurate exhibits high oxidation resistance in response to the oxidation reaction when receiving released charges. In addition, melamine cyanurate keeps its layered shape when oxidized, and thus it is cleaved at a molecular level to cause unoxidized melamine cyanurate to come out again to the surface.

The average particle diameter of the solid lubricant is preferably 0.01 μm or more and 20 μm or more, more preferably 1.0 μm or more and 15.0 μm or less, and still more preferably 2.0 μm or more and 5.0 μm or less, from the viewpoint of a transfer maintenance property and cleaning maintenance property.

The solid lubricant having an average particle diameter within the above-described ranges exhibits lubricity, and even when the solid lubricant is oxidatively deteriorated because of released charges, it exhibits cleavability and the lubricity is likely to be maintained. This further improves the transfer maintenance property and the cleaning maintenance property.

The average particle diameter of the solid lubricant is measured as follows.

A measurement sample is collected from a target intermediate transfer belt, and the surface side of the coating body of the measurement sample (that is, the belt outer peripheral surface side) is observed with a transmission electron microscope (TEM). The maximum diameter of each of 50 solid lubricant particles is defined as the particle diameter, and the average value thereof is defined as the average particle diameter.

The coverage of the coating body is preferably 10% or more, more preferably 20% or more, still more preferably 30% or more, and particularly preferably 40% or more, from the viewpoint of a transfer maintenance property and cleaning maintenance property.

When the coverage of the coating body is high (specifically, when the coverage of the coating body is preferably 30% or more and more preferably 40% or more), the coating body exhibits lubricity and even when the solid lubricant is oxidatively deteriorated because of released charges, it exhibits cleavability and the lubricity is likely to be maintained. This further improves the transfer maintenance property and the cleaning maintenance property.

However, when the coverage of the coating body is too high, the transfer maintenance property tends to degrade, and therefore, the coverage of the coating body is preferably 90% or less, preferably 70% or less, and more preferably 60%.

The coverage of the coating body is measured as follows.

An X-ray photoelectron spectroscopy (XPS) measurement is performed on the outer peripheral surface of the intermediate transfer belt to be measured. Specifically, the XPS measurement is performed with JPS-9000MX manufactured by JEOL Ltd. as a measurement device, by using MgKα rays as an X-ray source and setting an acceleration voltage to 10 kV and an emission current to 30 mA.

From the spectrum obtained under the above-described conditions, a component derived from the material of the coating body and a component derived from the material of a layer under the coating body are subjected to peak separation, whereby the coverage of the coating body is quantified. In the peak separation, the measured spectrum is separated into components by curve fitting using the least squares method.

As a component spectrum to be a base of the separation, a spectrum obtained by independently measuring the material of the coating body and the material of the layer under the coating body is used. Then, the coverage is obtained from the ratio of the spectral intensity of the material of the coating body to the total sum of all spectral intensities obtained by the measurement.

(Layer Structure)

The intermediate transfer belt according to the exemplary embodiment has a layer structure including a belt main body and the coating body provided on the outer peripheral surface of the belt main body.

The belt main body may be a single layer of a resin base material layer or a stacked body including a resin base material layer.

Examples of the stacked body including the resin base material layer include a stacked body in which an elastic layer is provided on the outer peripheral surface of the resin base material layer, a stacked body in which a resin layer is provided on the inner peripheral surface of the resin base material layer, and a stacked body including an elastic layer provided on the outer peripheral surface of the resin based material layer and a resin layer provided on the inner peripheral surface of the resin base material layer.

The elastic layer provided on the outer peripheral surface of the resin base material layer and the resin layer on the inner peripheral surface of the resin base material layer may be known layers employed in an intermediate transfer belt.

(Resin Base Material Layer)

The resin base material layer includes, for example, a resin and a conductive agent. The resin base material layer may contain other known components as necessary.

—Resin—

Examples of the resin include a polyimide resin (PI resin), a polyamide-imide resin (PAI resin), an aromatic polyether ketone resin (e.g., an aromatic polyether ether ketone resin), a polyphenylene sulfide resin (PPS resin), a polyether imide resin (PEI resin), a polyester resin, a polyamide resin, and a polycarbonate resin.

From the viewpoint of mechanical strength and the dispersibility of the conductive agent, the resin is preferably a polyimide-based resin (that is, a resin including a structural unit having an imide bond), more preferably a polyimide resin or a polyamide-imide resin, and still more preferably a polyimide resin.

Examples of the polyimide resin include an imidized product of a polyamic acid (precursor of polyimide resin), which, for example, is a polymer of a tetracarboxylic dianhydride and a diamine compound.

Examples of the polyimide resin include a resin having a structural unit represented by the following general formula (I).

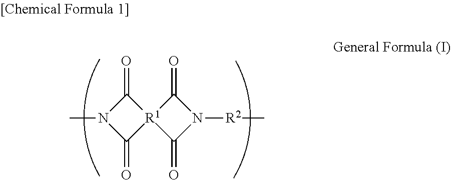

In the general formula (I), R¹ represents a tetravalent organic group, and R² represents a divalent organic group.

Examples of the tetravalent organic group represented by R¹ include an aromatic group, an aliphatic group, a cyclic aliphatic group, a group formed by combination of an aromatic group and an aliphatic group, and a group substituted with these groups. Specific examples of the tetravalent organic group include a residue of the tetracarboxylic dianhydrides described below.

Examples of the divalent organic group represented by R² include an aromatic group, an aliphatic group, a cyclic aliphatic group, a group formed by combination of an aromatic group and an aliphatic group, and a group substituted with these groups. Specific examples of the divalent organic group include a residue of the diamine compounds described below.

Specific examples of the tetracarboxylic dianhydride used as a raw material of the polyimide resin include pyromellitic dianhydride, 3,3′,4,4′-benzophenone tetracarboxylic dianhydride, 3,3′,4,4′-biphenyl tetracarboxylic dianhydride, 2,3,3′,4-biphenyl tetracarboxylic dianhydride, 2,3,6,7-naphthalene tetracarboxylic dianhydride, 1,2,5,6-naphthalene tetracarboxylic dianhydride, 1,4,5,8-naphthalene tetracarboxylic dianhydride, 2,2′-bis(3,4-dicarboxyphenyl)sulfonic dianhydride, perylene-3,4,9,10-tetracarboxylic dianhydride, bis(3,4-dicarboxyphenyl)ether dianhydride, and ethylene tetracarboxylic dianhydride.

Specific examples of the diamine compound used as raw materials of the polyimide resin include 4,4′-diaminodiphenyl ether, 4,4′-diaminodiphenyl methane, 3,3′-diaminodiphenyl methane, 3,3′-dichlorobenzidine, 4,4′-diaminodiphenyl sulfide, 3,3′-diaminodiphenyl sulfone, 1,5-diaminonaphthalene, m-phenylenediamine, p-phenylenediamine, 3,3′-dimethyl-4,4′-biphenyldiamine, benzidine, 3,3′-dimethylbenzidine, 3,3′-dimethoxybenzidine, 4,4′-diaminodiphenyl sulfone, 4,4′-diaminodiphenyl propane, 2,4-bis(3-amino-tert-butyl)toluene, bis(p-β-amino-tert-butylphenyl)ether, bis(p-β-methyl-6-aminophenyl)benzene, bis-p-(1,1-dimethyl-5-amino-pentyl)benzene, 1-isopropyl-2,4-m-phenylenediamine, m-xylylenediamine, p-xylylenediamine, di(p-aminocyclohexyl)methane, hexamethylenediamine, heptamethylenediamine, octamethylenediamine, nonamethylenediamine, decamethylenediamine, diaminopropyltetramethylene, 3-methylheptamethylenediamine, 4,4-dimethylheptamethylenediamine, 2,11-diaminododecane, 1,2-bis-3-aminopropoxyethane, 2,2-dimethylpropylenediamine, 3-methoxyhexamethylenediamine, 2,5-dimethylheptamethylenediamine, 3-methylheptamethylenediamine, 5-methylnonamethylenediamine, 2,17-diaminoeicosadecane, 1,4-diaminocyclohexane, 1,10-diamino-1,10-dimethyldecane, 12-diaminooctadecane, 2,2-bis[4-(4-aminophenoxy)phenyl]propane, piperazine, H₂N(CH₂)₃O(CH₂)₂O(CH₂)NH₂, H₂N(CH₂)₃S(CH₂)₃NH₂, and H₂N(CH₂)₃N(CH₃)₂(CH₂)₃NH₂.

Examples of the polyamide-imide resin include a resin having an imide bond and an amide bond in a repeating unit.

More specifically, examples of the polyamide-imide resin include a polymer of a trivalent carboxylic acid compound (also referred to as a tricarboxylic acid) having an acid anhydride group and a diisocyanate compound or diamine compound.

As the tricarboxylic acid, trimellitic anhydride or a derivative thereof is preferable. In addition to the tricarboxylic acid, a tetracarboxylic dianhydride, an aliphatic dicarboxylic acid, an aromatic dicarboxylic acid, or the like may be used in combination.

Examples of the diisocyanate compound include 3,3′-dimethylbiphenyl-4,4′-diisocyanate, 2,2′-dimethylbiphenyl-4,4′-diisocyanate, biphenyl-4,4′-diisocyanate, biphenyl-3,3′-diisocyanate, biphenyl-3,4′-diisocyanate, 3,3′-diethylbiphenyl-4,4′-diisocyanate, 2,2′-diethylbiphenyl-4,4′-diisocyanate, 3,3′-dimethoxybiphenyl-4,4′-diisocyanate, 2,2′-dimethoxybiphenyl-4,4′-diisocyanate, naphthalene-1,5-diisocyanate, and naphthalene-2,6-diisocyanate.

Examples of the diamine compound include a compound having a structure similar to that of the isocyanate described above and having an amino group instead of an isocyanate group.

Here, the content of the resin relative to the resin base material layer is preferably 60 mass % or more and 95 mass % or less, more preferably 70 mass % or more and 95 mass % or less, and still more preferably 75 mass % or more and 90 mass % or less, from the viewpoints of mechanical strength, volume resistivity adjustment, and the like.

—Conductive Agent—

Examples of the conductive agent include a powder having conductivity (for example, having a volume resistivity of less than 10⁷ Ω·cm, the same applies hereinafter) or semiconductivity (for example, having a volume resistivity of 10⁷ Ω·cm or more and 10¹³ Ω·cm or less, the same applies hereinafter).

Specifically, the conductive agent is not particularly limited, and examples thereof include a carbon black, a metal (e.g., aluminum and nickel), a metal oxide (e.g., yttrium oxide and tin oxide), and an ion conductive substance (e.g., potassium titanate and LiCl).

The conductive agent is selected depending on the purpose of use, but a carbon black is preferable.

Examples of the carbon black include Ketjen black, oil furnace black, channel black, and acetylene black. As the carbon black, a carbon black having a treated surface (hereinafter, also referred to as “surface-treated carbon black”) may be used.

The surface-treated carbon black is obtained by imparting, for example, a carboxy group, a quinone group, a lactone group, a hydroxy group, or the like to the surface thereof.

Examples of the surface treatment method include an air oxidation method in which a reaction is caused by contact with air in a high-temperature atmosphere, a method in which a reaction with nitrogen oxide or ozone is caused at room temperature (for example, 22° C.), and a method in which air oxidation is performed in a high-temperature atmosphere and then oxidation is performed with ozone at a low temperature.

The average particle diameter of the carbon black is preferably 2 nm or more and 40 nm or less, more preferably 8 nm or more and 20 nm or less, and still more preferably 10 nm or more and 15 nm or less, from the viewpoints of dispersibility, mechanical strength, volume resistivity, film-forming properties, and the like.

The average particle diameter of the conductive agent (in particular, carbon black) is measured by the following method.

First, a measurement sample of 100 nm in thickness is collected from the resin base material layer with a microtome, and the measurement sample is observed with a transmission electron microscope (TEM). The diameter of a circle having the same area as a projected area of each of 50 particles of the conductive agent (that is, the equivalent circle diameter) is defined as the particle diameter, and the average value thereof is defined as the average particle diameter.

The content of the conductive agent is preferably 10 mass % or more and 50 mass % or less, more preferably 12 mass % or more and 40 mass % or less, and still more preferably 15 mass % or more and 30 mass % or less relative to the resin base material layer, from the viewpoints of mechanical strength and volume resistivity.

—Other Component—

Examples of other components include a filler for improving mechanical strength, an antioxidant for preventing thermal deterioration of the belt, a surfactant for improving fluidity, and a heat-resistant aging inhibitor.

When other components are contained, the content thereof is preferably more than 0 mass % and 10 mass % or less, more preferably more than 0 mass % and 5 mass % or less, and still more preferably more than 0 mass % and 1 mass % or less relative to the resin base material layer.

—Thickness of Resin Base Material Layer—

The thickness of the resin base material layer is preferably 60 m or more and 120 m or less and more preferably 80 m or more and 120 m or less from the viewpoint of mechanical strength.

The thickness of the resin base material layer is measured as follows.

A cross section of the resin base material layer in a thickness direction is observed with an optical microscope or a scanning electron microscope, the thickness of the layer is measured at 10 places, and the average value thereof is taken as the thickness of the resin base material layer.

(Volume Resistivity of Intermediate Transfer Belt)

The common logarithm value of the volume resistivity of the intermediate transfer belt when a voltage of 500 V is applied for 10 seconds is preferably 9.0 (log Ω·cm) or more and 13.5 (log Ω·cm) or less, more preferably 9.5 (log Ω·cm) or more and 13.2 (log Ω·cm) or less, and particularly preferably 10.0 (log Ω·cm) or more and 12.5 (log Ω·cm) or less from the viewpoint of a transfer property.

The measurement of the volume resistivity of the intermediate transfer belt when a voltage of 500 V is applied for 10 seconds is performed by the following method.

The volume resistivity (log Ω·cm) of the intermediate transfer belt is measured at 18 points including 6 points at equal intervals in a circumferential direction and 3 points at the center and both ends in a width direction of the intermediate transfer belt with a voltage of 500 V, an application time of 10 seconds, and a pressure of 1 kgf using a micro ammeter (R8430A manufactured by Advantest Corporation) as a resistance measuring device and a UR probe (manufactured by Mitsubishi Chemical Analytech Co., Ltd.) as a probe, and the average value is calculated. The measurement is performed in an environment at a temperature of 22° C. and a humidity of 55% RH.

(Surface Resistivity of Intermediate Transfer Belt)

The common logarithm value of the surface resistivity of the intermediate transfer belt when a voltage of 500 V is applied for 10 seconds to the outer peripheral surface is preferably 10.0 (log Ω/suq.) or more and 15.0 (log Ω/suq.) or less, more preferably 10.5 (log Ω/suq.) or more and 14.0 (log Ω/suq.) or less, and particularly preferably 11.0 (log Ω/suq.) or more and 13.5 (log Ω/suq.) or less from the viewpoint of a transfer property to uneven paper.

The unit log Ω/suq. of the surface resistivity represents the surface resistivity as a logarithmic value of a resistance value per unit area and is also noted as log (Ω/suq.), log Ω/square, log Ω/SQUARE, or the like.

The measurement of the surface resistivity of the intermediate transfer belt when a voltage of 500 V is applied for 10 seconds to the outer circumferential surface is performed by the following method.

The surface resistivity (log Ω/suq.) of the outer peripheral surface of the endless belt is measured at a total of 18 points including 6 points on the outer peripheral surface of the intermediate transfer belt at equal intervals in a circumferential direction and 3 points at the center and both ends in a width direction with a voltage of 500 V, an application time of 10 seconds, and a pressure of 1 kgf using a micro ammeter (R8430A manufactured by Advantest Corporation) as a resistance measuring device and a UR probe (manufactured by Mitsubishi Chemical Analytech Co., Ltd.) as a probe, and the average value is calculated. The measurement is performed in an environment at a temperature of 22° C. and a humidity of 55% RH.

<Method for Producing Intermediate Transfer Belt>

A method for producing the intermediate transfer belt according to the exemplary embodiment includes, for example, preparing a belt main body and forming a coating body of a solid lubricant on the outer peripheral surface of the belt main body.

In preparing the belt main body, the belt main body is obtained by using a known method for producing an intermediate transfer belt.

In forming the coating body, the coating body of a solid lubricant is formed on the outer peripheral surface of the belt main body by:

1) after a powder of a solid lubricant is attached to the outer peripheral surface of the belt main body, performing an operation of rubbing the attached material multiple times;

2) performing an operation of rubbing a molded product (e.g., a rod-shaped or plate-shaped molded product) of a solid lubricant against the outer peripheral surface of the belt main body multiple times; or the like.

The coverage of the coating body may be adjusted by the number of the above-described operations.

[Transfer Device]

### First Exemplary Embodiment

A transfer device according to a first exemplary embodiment includes an intermediate transfer belt having an outer peripheral surface onto which a toner image is transferred, a primary transfer device having a primary transfer member that primarily transfers a toner image formed on a surface of an image holding body onto the outer peripheral surface of the intermediate transfer belt, a secondary transfer device having a secondary transfer member that is disposed in contact with the outer peripheral surface of the intermediate transfer belt and secondarily transfers the toner image transferred onto the outer peripheral surface of the intermediate transfer belt onto a surface of a recording medium, and a cleaning device having a cleaning member that cleans the outer peripheral surface of the intermediate transfer belt. The intermediate transfer belt according to the exemplary embodiment is used as the intermediate transfer belt.

In the primary transfer device, the primary transfer member is disposed to face the image holding body with the intermediate transfer belt interposed therebetween. In the primary transfer device, the toner image is primarily transferred onto the outer peripheral surface of the intermediate transfer belt by applying a voltage having a polarity opposite to the charging polarity of toner to the intermediate transfer belt by the primary transfer member.

In the secondary transfer device, the secondary transfer member is disposed on the toner image holding side of the intermediate transfer belt. The secondary transfer device includes, for example, the secondary transfer member and a back surface member disposed on the side opposite to the toner image holding side of the intermediate transfer belt. In the second transfer device, the toner image on the intermediate transfer belt is secondary transferred onto the recording medium by sandwiching the intermediate transfer belt and the recording medium between the secondary transfer member and the back surface member and forming a transfer electric field.

The secondary transfer member may be a secondary transfer roller or may be a secondary transfer belt. It is noted that for example, a back surface roller is applied for the back surface member.

In the cleaning device, the cleaning member is disposed on the toner image holding side of the intermediate transfer belt. The cleaning device includes, for example, the cleaning member and a back surface member disposed on the side opposite to the toner image holding side of the intermediate transfer belt. In the cleaning device, for example, the outer peripheral surface of the intermediate transfer belt is cleaned by the cleaning member while the intermediate transfer belt is sandwiched between the cleaning member and the back surface member.

Examples of the cleaning member include a cleaning blade and a cleaning brush.

The transfer device according to the exemplary embodiment may be a transfer device that transfers a toner image onto a surface of a recording medium via a plurality of intermediate transfer bodies. That is, the transfer device may be, for example, a transfer device that primarily transfers a toner image from an image holding body to a first intermediate transfer body, secondarily transfers the toner image from the first intermediate transfer body to a second intermediate transfer body, and then tertiary transfers the toner image from the second intermediate transfer body to a recording medium.

In the transfer device, the intermediate transfer belt according to the exemplary embodiment is applied to at least one of the plurality of intermediate transfer bodies.

### Second Exemplary Embodiment

A transfer device according to a second exemplary embodiment includes an intermediate transfer belt having an outer peripheral surface onto which a toner image is transferred, a primary transfer device having a primary transfer member that primarily transfers a toner image formed on a surface of an image holding body onto the outer peripheral surface of the intermediate transfer belt, a secondary transfer device having a secondary transfer member that is disposed in contact with the outer peripheral surface of the intermediate transfer belt and secondarily transfers the toner image transferred onto the outer peripheral surface of the intermediate transfer belt onto a surface of a recording medium, a cleaning device having a cleaning member that cleans the outer peripheral surface of the intermediate transfer belt, and a solid lubricant supply device that supplies a solid lubricant selected from an organic layered compound or an organic-inorganic composite layered compound to the outer peripheral surface of the intermediate transfer belt.

In the transfer device according to the second exemplary embodiment, with the above-described configuration, the transfer maintenance property and the cleaning maintenance property of the intermediate transfer belt are improved. The reason is assumed as follows.

There is a conventionally known transfer device including a solid lubricant supply device that supplies a fatty acid metal salt as a solid lubricant to an outer peripheral surface of an intermediate transfer belt to improve the transfer property of the intermediate transfer belt.

However, as described above, the fatty acid metal salt degrades the transfer property of the intermediate transfer belt over time, and the inorganic layered compound degrades the cleaning property over time. In contrast, when a solid lubricant selected from an organic layered compound or an organic-inorganic composite layered compound is supplied to the outer peripheral surface of the intermediate transfer belt, the transfer maintenance property and the cleaning maintenance property improve because of the wall property and low hardness of the organic layered compound or organic-inorganic composite layered compound.

From the above, it is presumed that the transfer maintenance property and the cleaning maintenance property of the intermediate transfer belt improve in the transfer device according to the second exemplary embodiment.

In the transfer device according to the second exemplary embodiment, the solid lubricant supply device is provided, for example, downstream of the secondary transfer device in a rotation direction of the intermediate transfer belt and upstream of the cleaning device in the rotation direction of the intermediate transfer belt.

The solid lubricant supply device includes, for example, a molded product (e.g., a rod-shaped or plate-shaped molded product) of a solid lubricant and a lubricant supply member.

The molded product of the solid lubricant is obtained, for example, by compression-molding a powder of the solid lubricant.

Examples of the lubricant supply member include a rotary brush and a rubber roller, and among them, the rotary brush is preferable. The rotary brush and the rubber roller scrape off powder of the solid lubricant from the molded product of the solid lubricant while rotating and supply the solid lubricant to the outer peripheral surface of the intermediate transfer belt.

The supplied solid lubricant is rubbed against the outer peripheral surface of the intermediate transfer belt by the cleaning member, and a coating body of the solid lubricant is formed.

The solid lubricant supply device may include a sliding member provided in contact with the outer peripheral surface of the intermediate transfer belt, the sliding member being provided downstream of the lubricant supply member in the rotation direction of the intermediate transfer belt and upstream of the cleaning device in the rotation direction of the intermediate transfer belt. When the sliding member slides on the outer peripheral surface of the intermediate transfer belt with the supplied solid lubricant interposed therebetween, the solid lubricant is rubbed against the outer peripheral surface of the intermediate transfer belt to form a coating body of the solid lubricant.

From the viewpoint of the transfer maintenance property and cleaning maintenance property of the intermediate transfer belt, the solid lubricant supply device preferably supplies the solid lubricant to the outer peripheral surface of the intermediate transfer belt in an amount such that the coverage of the coating body of the solid lubricant is 10% or more (preferably 20% or more, more preferably 30% or more, and still more preferably 40% or more).

When the coverage of the coating body is high (specifically, when the coverage of the coating body is preferably 30% or more and more preferably 40% or more), the coating body exhibits lubricity and even when the solid lubricant is oxidatively deteriorated because of released charges, it exhibits cleavability and the lubricity is likely to be maintained. This further improves the transfer maintenance property and the cleaning maintenance property.

However, when the coverage of the coating body is too high, the transfer maintenance property tends to degrade. The coverage of the coating body is preferably 90% or less, preferably 70% or less, and more preferably 60%.

The measurement of the coverage of the coating body is the same as the measurement of the coverage of the coating body described for the intermediate transfer belt according to the above-described exemplary embodiment.

In the transfer device according to the second exemplary embodiment, the aspect of the solid lubricant is the same as that of the solid lubricant described for the intermediate transfer belt according to the above-described exemplary embodiment. In addition, the configuration of the transfer device other than the solid lubricant supply device is the same as the configuration described in the transfer device according to the above-described exemplary embodiment.

[Image Forming Apparatus]

An image forming apparatus according to an exemplary embodiment includes a toner image forming device that forms a toner image on a surface of an image holding body and a transfer device that transfers the toner image formed on the surface of the image holding body onto a surface of a recording medium. The transfer device according to the first exemplary embodiment or the transfer device according to the second exemplary embodiment is used as the transfer device.

Examples of the toner image forming device include a device including an image holding body, a charging device that charges a surface of the image holding body, an electrostatic latent image forming device that forms an electrostatic latent image on the charged surface of the image holding body, and a developing device that develops the electrostatic latent image formed on the surface of the image holding body with a developer containing toner to form a toner image.

The image forming apparatus according to the exemplary embodiment may be a known image forming apparatuses, such as an apparatus including a fixing unit that fixes a toner imager transferred on a surface of a recording medium, an apparatus including a cleaning unit that cleans a surface of an image holding body before charging after transferring a toner image, an apparatus including a charge eliminating unit that eliminates charges by irradiating a surface of an image holding body with charge eliminating light before charging after transferring a toner image, and an apparatus including an image holding body heating member to reduce a relative temperature by increasing a temperature of the image carrier.

The image forming apparatus according to the exemplary embodiment may be either a dry development type image forming apparatus or a wet development type (a development type using a liquid developer) image forming apparatus.

In the image forming apparatus according to the exemplary embodiment, for example, a part including the image holding body may have a cartridge structure (process cartridge) detachably attached to the image forming apparatus. As the process cartridge, for example, a process cartridge including a toner image forming device and a transfer device is suitably used.

Hereinafter, an example of the image forming apparatus according to the exemplary embodiment will be described with reference to the drawings. The image forming apparatus according to the exemplary embodiment is not limited to this example. It is noted that main parts illustrated in the drawings will be described, and descriptions of other parts will be omitted.

An example of the image forming apparatus described with reference to the drawings is an image forming apparatus including the transfer device according to the second exemplary embodiment as a transfer device. An image forming apparatus including the transfer device according to the first exemplary embodiment as a transfer device may or may not include a solid lubricant supply device, but it does not have to include a solid lubricant supply device.

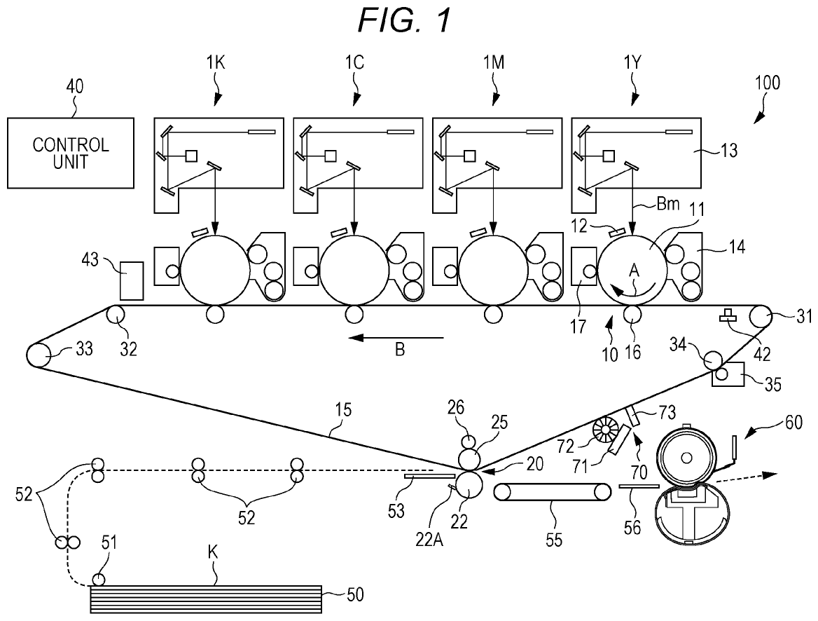

(Image forming apparatus) FIG. 1 is a schematic configuration diagram illustrating a configuration of the image forming apparatus according to the exemplary embodiment.

As illustrated in FIG. 1, an image forming apparatus 100 according to the present exemplary embodiment is, for example, an intermediate transfer type image forming apparatus typically called a tandem type and includes a plurality of image forming units 1Y, 1M, 1C, 1K (examples of a toner image forming device) that form toner images of respective color components by electrophotography, a primary transfer unit 10 that sequentially transfers (primarily transfers) the toner images of respective color components formed by the image forming units 1Y, 1M, 1C, 1K onto an intermediate transfer belt 15, a secondary transfer unit 20 that collectively transfers (secondary transfers) the superimposed toner images transferred onto the intermediate transfer belt 15 onto a paper K as a recording medium, and a fixing device 60 that fixes the secondarily transferred images on the paper K. The image forming apparatus 100 also includes a control unit 40 that controls the operation of each device (each unit).

Each of the image forming units 1Y, 1M, 1C, 1K of the image forming apparatus 100 includes a photoreceptor 11 (an example of an image holding body) that holds a toner image formed on its surface and rotates in the direction of the arrow A.

Around the photoreceptor 11, a charger 12 that charges the photoreceptor 11 is provided as an example of a charging unit, and a laser exposure device 13 (an exposure beam is denoted by reference Bm in FIG. 1) that writes an electrostatic latent image on the photoreceptor 11 is provided as an example of a latent image forming unit.

Around the photoreceptor 11, a development counter 14 that contains toner of each color component and visualizes the electrostatic latent image on the photoreceptor 11 with the toner is provided as an example of a developing unit, and a primary transfer roller 16 that transfers the toner image of each color component formed on the photoreceptor 11 to the intermediate transfer belt 15 at the primary transfer unit 10 is provided.

Further, a photoreceptor cleaner 17 that removes residual toner on the photoreceptor 11 is provided around the photoreceptor 11, and electrophotographic devices including the charger 12, the laser exposure device 13, the development counter 14, the primary transfer roller 16, and the photoreceptor cleaner 17 are sequentially arranged along the rotation direction of the photoreceptor 11. The image forming units 1Y, 1M, 1C, 1K are arranged substantially linearly in the order of yellow (Y), magenta (M), cyan (C), and black (K) from the upstream side of the intermediate transfer belt 15.

The intermediate transfer belt 15 is driven in circles (rotated) by various rollers in the direction of B illustrated in FIG. 1 at a speed suitable for the purpose. The various rollers include a drive roller 31 that is driven by a motor (not illustrated) having an excellent constant speed to rotate the intermediate transfer belt 15, a support roller 32 that supports the intermediate transfer belt 15 extending substantially linearly along the arrangement direction of the respective photoreceptors 11, a tension applying roller 33 that functions as a correction roller applying tension to the intermediate transfer belt 15 and preventing meandering of the intermediate transfer belt 15, a back surface roller 25 provided at the secondary transfer unit 20, and a cleaning back surface roller 34 that is provided at a cleaning unit and scrapes off residual toner on the intermediate transfer belt 15.

The primary transfer unit 10 includes the primary transfer roller 16 disposed to face the photoreceptor 11 with the intermediate transfer belt 15 interposed therebetween. The primary transfer roller 16 is disposed in pressure contact with the photoreceptor 11 with the intermediate transfer belt 15 interposed therebetween, and further, a voltage (primary transfer bias) having a polarity opposite to the charging polarity of toner (negative polarity, the same applying hereinafter) is applied to the primary transfer roller 16. This causes toner images on the respective photoreceptors 11 to be electrostatically attracted to the intermediate transfer belt 15 in a sequential manner to form superimposed toner images on the intermediate transfer belt 15.

The secondary transfer unit 20 includes the back surface roller 25 and a secondary transfer roller 22 disposed on the toner image holding surface side of the intermediate transfer belt 15.

The back surface roller 25 is formed to have a surface resistivity of 1×10⁷ Ω/SQUARE or more and 1×10¹⁰Ω/SQUARE or less. The hardness of the back surface roller 25 is set, for example, 70° (ASKER C: KOBUNSHI KEIKI CO., LTD., the same applies hereinafter). The back surface roller 25 is disposed on the back surface side of the intermediate transfer belt 15 to constitute a counter electrode of the secondary transfer roller 22. A power feeding roller 26 made of metal to which a secondary transfer bias is stably applied is disposed in contact with the back surface roller 25.

The secondary transfer roller 22 is a cylindrical roller having a volume resistivity of 10^{7.5} Ωcm or more and 10^{8.5} Ωcm or less. The secondary transfer roller 22 is disposed in pressure contact with the back surface roller 25 with the intermediate transfer belt 15 interposed therebetween. Further, the secondary transfer roller 22 is grounded to form a secondary transfer bias between the secondary transfer roller 22 and the back surface roller 25, and a toner image is secondarily transferred onto the paper K conveyed to the secondary transfer unit 20.

On the downstream side of the secondary transfer unit 20 with respect to the intermediate transfer belt 15, an intermediate transfer belt cleaning member 35 that removes residual toner and paper dust on the intermediate transfer belt 15 after secondary transfer to clean the outer peripheral surface of the intermediate transfer belt 15 is provided in such a manner as to freely come into contact with and separate from the intermediate transfer belt 15. A secondary transfer roller cleaning member 22A that removes residual toner and paper dust on the secondary transfer roller 22 after secondary transfer to clean the outer peripheral surface of the intermediate transfer belt 15 is provided downstream of the secondary transfer unit 20 with respect to the secondary transfer roller 22. The secondary transfer roller cleaning member 22A is, for example, a cleaning blade. However, it may be a cleaning roller.

A solid lubricant supply device 70 that supplies a solid lubricant is provided downstream of the secondary transfer unit 20 and upstream of the intermediate transfer belt cleaning member 35 with respect to the intermediate transfer belt 15.

The solid lubricant supply device 70 includes a molded product 71 of the solid lubricant, a lubricant supply member 72 that scrapes off the molded product of the solid lubricant and supplies the solid lubricant to the outer peripheral surface of the intermediate transfer belt 15, and a sliding member 73 that forms a coating body of the solid lubricant by rubbing the solid lubricant against the outer peripheral surface of the intermediate transfer belt 15 by sliding.

A configuration including the intermediate transfer belt 15, the primary transfer roller 16, the secondary transfer roller 22, the intermediate transfer belt cleaning member 35, and the solid lubricant supply device 70 corresponds to an example of the transfer device.

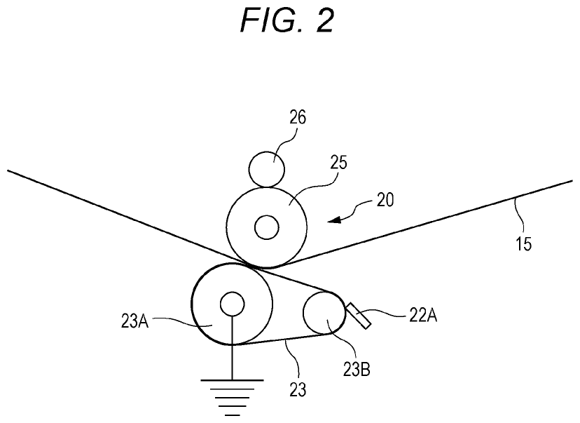

The image forming apparatus 100 may include a secondary transfer belt (an example of the secondary transfer member) instead of the secondary transfer roller 22. Specifically, as illustrated in FIG. 2, the image forming apparatus 100 may include a secondary transfer device including a secondary transfer belt 23, a drive roller 23A disposed to face the back surface roller 25 with the intermediate transfer belt 15 and the secondary transfer belt 23 interposed therebetween, and an idler roller 23B that stretches the secondary transfer belt 23 together with the drive roller 23A.

On the other hand, a reference sensor (home position sensor) 42 for generating a reference signal serving as a reference for taking an image forming timing in each of the image forming units 1Y, 1M, 1C, 1K is disposed upstream of the yellow image forming unit 1Y. An image density sensor 43 for adjusting image quality is disposed downstream of the black image forming unit 1K. The reference sensor 42 is formed so as to recognize a mark on the back side of the intermediate transfer belt 15 and generate the reference signal, so that, in accordance with an instruction from the control unit 40 based on the recognition of this reference signal, each of the image forming units 1Y, 1M, 1C, 1K start forming images.

Further, the image forming apparatus according to the exemplary embodiment includes, as a conveyance unit that conveys the paper K, a paper storage unit 50 that stores the paper K, a paper feeding roller 51 that picks up and conveys the paper K stacked in the paper storage unit 50 at a predetermined timing, a conveyance roller 52 that conveys the paper K fed by the paper feeding roller 51, a conveyance guide 53 that sends the paper K conveyed by the conveyance roller 52 to the secondary transfer unit 20, a conveyance belt 55 that conveys the paper K conveyed after the secondary transfer performed by the secondary transfer roller 22 to the fixing device 60, and a fixing inlet guide 56 that guides the paper K to the fixing device 60.

Next, a basic image formation process of the image forming apparatus according to the exemplary embodiment will be described.

In the image forming apparatus according to the exemplary embodiment, image data that is output from, for example, an image reading device (not illustrated) or a personal computer (PC) (not illustrated) is processed by an image processing device (not illustrated), and then image forming work is executed by the image forming units 1Y, 1M, 1C, 1K.

In the image processing device, input reflectance data is subjected to image processing such as shading correction, positional deviation correction, brightness/color space conversion, gamma correction, and various image editing such as frame erasing, color editing, and movement editing. The image data subjected to the image processing is converted into color material gradation data of the four colors of Y, M, C, K, and then outputted to the laser exposure device 13.

The laser exposure device 13 irradiates each photoreceptor 11 of the image forming units 1Y, 1M, 1C, 1K with an exposure beam Bm emitted from, for example, a semiconductor laser, according to the input color material gradation data. In each photoreceptor 11 of the image forming units 1Y, 1M, 1C, 1K, after the surface is charged by the charger 12, the surface is scanned and exposed by the laser exposure device 13, and an electrostatic latent image is formed.

The formed electrostatic latent images are developed as toner images of the respective colors, Y, M, C, K by the respective image forming units 1Y, 1M, 1C, 1K.

The toner images formed on the photoreceptors 11 of the image forming units 1Y, 1M, 1C, 1K are transferred onto the intermediate transfer belt 15 at the primary transfer unit 10 where the respective photoreceptors 1 are in contact with the intermediate transfer belt 15. More specifically, in the primary transfer unit 10, a voltage (primary transfer bias) having a polarity opposite to the charging polarity (negative polarity) of toner is applied to a base material of the intermediate transfer belt 15 by the primary transfer roller 16, and the toner images are sequentially superimposed on the outer peripheral surface of the intermediate transfer belt 15 to perform primary transfer.

After the toner images are primary transferred onto the outer peripheral surface of the intermediate transfer belt 15 in a sequential manner, the intermediate transfer belt 15 moves, and the toner images are conveyed to the secondary transfer unit 20. When the toner images are conveyed to the secondary transfer unit 20, the paper feeding roller 51 rotates in accordance with a timing in which the toner images are conveyed to the secondary transfer unit 20 in the conveyance unit, and the paper K of a desired size is supplied from the paper storage unit 50. The paper K supplied by the paper feeding roller 51 is conveyed by the conveyance roller 52 and reaches the secondary transfer unit 20 via the conveyance guide 53. Before the paper K reaches the secondary transfer unit 20, the paper K is temporarily stopped, and a position adjustment roller (not illustrated) rotates in accordance with a timing in which the intermediate transfer belt 15 holding the toner images moves, so that the position of the paper K and the positions of the toner images are adjusted.

In the secondary transfer unit 20, the secondary transfer roller 22 is pressed against the back surface roller 25 with the intermediate transfer belt 15 interposed therebetween. At this time, the paper K conveyed at a matched timing is sandwiched between the intermediate transfer belt 15 and the secondary transfer roller 22. At this time, when a voltage (secondary transfer bias) having the same polarity as the charging polarity (negative polarity) of toner is applied from the power feeding roller 26, a transfer electric field is formed between the secondary transfer roller 22 and the back surface roller 25. Then, the unfixed toner images held on the intermediate transfer belt 15 are collectively and electrostatically transferred onto the paper K at the secondary transfer unit 20 pressed by the secondary transfer roller 22 and the back surface roller 25.

Thereafter, the paper K on which the toner images have been electrostatically transferred is conveyed as it is in a state of being peeled off from the intermediate transfer belt 15 by the secondary transfer roller 22 and is conveyed to the transfer belt 55 provided downstream of the secondary transfer roller 22 in the paper conveying direction. The conveyance belt 55 conveys the paper K to the fixing device 60 in accordance with the optimum conveyance speed in the fixing device 60. The unfixed toner images on the paper K conveyed to the fixing device 60 are subjected to a fixing processing with heat and pressure by the fixing device 60, thereby being fixed on the paper K. Then, the paper K with the fixed images is conveyed to an ejected paper storage unit (not illustrated) provided in an ejection unit of the image forming apparatus.

After the transfer to the paper K is completed, residual toner remaining on the intermediate transfer belt 15 is conveyed to the cleaning unit with the rotation of the intermediate transfer belt 15 and is removed from the intermediate transfer belt 15 by the cleaning back surface roller 34 and the intermediate transfer belt cleaning member 35.

Although the exemplary embodiments have been described above, the present invention is not limited to the exemplary embodiments, and various modifications, changes, and improvements can be made.

### EXAMPLES

Hereinafter, examples of the present invention will be described. The present invention is not limited to the following examples. In the following description, all of “part” and “%” are based on mass unless otherwise specified.

### Example 1

—Belt Main Body Production Step—

A PI precursor solution was prepared by dissolving a polyamic acid composed of a polymer of 3,3′,4,4′-biphenyl tetracarboxylic acid dianhydride and 4,4′-diaminodiphenyl ether in N-methyl-2-pyrrolidone (NMP). The PI precursor solution was a solution in which the solid content ratio of the polyimide resin after imidization of the polyamic acid was 18 mass %.

Next, to the PI precursor solution, carbon black (FW200: manufactured by Orion Engineered Carbons, average particle diameter=13 nm) was added to the PI precursor solution so as to be in an amount of 19 parts by mass relative to 100 parts by mass of the solid content of the polyamic acid, and the obtained material was mixed and stirred to prepare a carbon black-dispersed PI precursor solution.

Next, the carbon black-dispersed PI precursor solution was jetted onto the outer surface of a cylindrical body made of aluminum through a dispenser with a width of 500 mm while the cylindrical body was rotated.

Thereafter, the cylindrical body was heated and dried at 140° C. for 30 minutes while being kept horizontal, and heated for 120 minutes so as to reach a maximum temperature of 320° C. Then, a belt main body (that is, a single layer body of a polyimide layer) having a thickness of 80 m was cut into 363 mm in width.

—Solid Lubricant Application Step—

Next, the obtained belt main body was fitted into the cylindrical body made of aluminum again and set in a rotary jig.

Next, 5 g of melamine cyanurate “MC6000” (manufactured by Nissan Chemical Industries, Ltd.) as a solid lubricant was attached to a nonwoven fabric (TechniCloth TX609).

Thereafter, the solid lubricant attached portion of the nonwoven fabric was brought into contact with the outer peripheral surface at an end in a width direction of the belt main body rotating at a rotation speed 20 rpm and then moved to the other end side, so that the solid lubricant was spirally rubbed. This coating operation was repeated seven times.

Through the above-described steps, an intermediate transfer belt was obtained.

### Example 2

An intermediate transfer belt was obtained in the same manner as in Example 1 except that the application operation was performed three times in the lubricant application step.

### Example 3

An intermediate transfer belt was obtained in the same manner as in Example 1 except that the application operation was performed 10 times in the lubricant application step.

### Example 4

An intermediate transfer belt was obtained in the same manner as in Example 1 except that the application operation was performed 20 times in the lubricant application step.

### Example 5

An intermediate transfer belt was obtained in the same manner as in Example 1, except that in the lubricant application step, copper phthalocyanine (manufactured by Tokyo Chemical Industry Co., Ltd.) was used as the solid lubricant, and the application operation was performed three times.

### Example 6

An intermediate transfer belt was obtained in the same manner as in Example 1, except that in the lubricant application step, copper phthalocyanine (manufactured by Tokyo Chemical Industry Co., Ltd.) was used as the solid lubricant, and the application operation was performed seven times.

### Example 7

An intermediate transfer belt was obtained in the same manner as in Example 1, except that in the lubricant application step, melamine cyanurate “MC-1F” (manufactured by Sakai Chemical Industry Co., Ltd.) was used as the solid lubricant, and the application operation was performed seven times.

### Example 8

An intermediate transfer belt was obtained in the same manner as in Example 1, except that in the lubricant application step, melamine cyanurate “MC-1N” (manufactured by Sakai Chemical Industry Co., Ltd.) was used as the solid lubricant, and the application operation was performed seven times.

### Example 9

An intermediate transfer belt was obtained in the same manner as in Example 1, except that in the lubricant application step, melamine cyanurate “MC-2010N” (manufactured by Sakai Chemical Industry Co., Ltd.) was used as the solid lubricant, and the application operation was performed seven times.

### Example 10

An intermediate transfer belt was obtained in the same manner as in Example 1, except that in the lubricant application step, melamine cyanurate “MC-4500” (manufactured by Nissan Chemical Industries, Ltd.) was used as the solid lubricant, and the application operation was performed seven times.

### Example 11

An intermediate transfer belt was obtained in the same manner as in Example 1, except that in the lubricant application step, melamine cyanurate “MC-4000” (manufactured by Nissan Chemical Industries, Ltd.) was used as the solid lubricant, and the application operation was performed seven times.

### Example 12

An intermediate transfer belt was obtained in the same manner as in Example 1, except that in the lubricant application step, melamine cyanurate “MC6000” (manufactured by Nissan Chemical Industries, Ltd.) was used as the solid lubricant, and the application operation was performed once.

### Comparative Example 1

An intermediate transfer belt was obtained in the same manner as in Example 1, except that in the lubricant application step, zinc stearate (manufactured by FUJIFILM Wako Pure Chemical Corporation) was used as the solid lubricant, and the application operation was performed seven times.

### Comparative Example 2

An intermediate transfer belt was obtained in the same manner as in Example 1, except that in the lubricant application step, boron nitride UHP-Sl (manufactured by Showa Denko K.K.) was used as the solid lubricant, and the application operation was performed seven times.

<Evaluation>

(Property)

For the obtained intermediate transfer belts, the coverage of the coating body was measured in accordance with the method described above.

(Evaluation)

Each of the obtained intermediate transfer belts was set in an image forming apparatus “Versant 180 press (manufactured by FUJIFILM Business Innovation Corp.)”. Then, the following evaluations were performed.

—Transfer Maintenance Property—

A blue halftone 30% image was output on 1,000 sheets of embossed paper (embossed, snow color), the filling of recesses was visually checked, and the transfer maintenance property was evaluated by comparing the images on the first sheet and the 1,000th sheet. The evaluation criteria are as follows.

A+(⊙+): There are no voids in recesses in the initial stage or after 1,000 sheets.

A (⊙): Slight voids in recesses are observed constantly in the initial stage and after 1,000 sheets.

B (◯): Voids in recesses after 1,000 sheets slightly deteriorated as compared with the initial stage.

C (Δ): Voids in recesses after 1,000 sheets significantly deteriorated as compared with the initial stage, but it was allowable.

D (x): Voids in recesses after 1,000 sheets deteriorated to an unacceptable level as compared with the initial stage.

—Cleaning Maintenance Property—

A blue halftone 30% image was output on 1,000 sheets of embossed paper (embossed, snow color), the presence or absence of color streaks after 1,000 sheets was visually checked, and the cleaning maintenance property was evaluated. The evaluation criteria are as follows.

B (◯): No color streak is generated.

C (Δ): A slight color streak is generated.

D (x): Color streaks are generated on the entire surface.

TABLE 1

| | Solid lubricant | | Coverage of | Evaluation | |
|---|---|---|---|---|---|
| | | Average particle | coating body of | Transfer | Cleaning |
| | | diameter | solid lubricant | maintenance | maintenance |
| | Type | (μm) | (%) | property | property |
| Example 1 | Melamine cyanurate | 2 | 50 | A + (⊙+) | B (◯) |
| Example 2 | Melamine cyanurate | 2 | 30 | A (⊙) | B (◯) |
| Example 3 | Melamine cyanurate | 2 | 70 | A (⊙) | B (◯) |
| Example 4 | Melamine cyanurate | 2 | 90 | A (⊙) | B (◯) |
| Example 5 | Copper phthalocyanine | 0.02 | 30 | B (◯) | B (◯) |
| Example 6 | Copper phthalocyanine | 0.02 | 50 | B (◯) | B (◯) |
| Example 7 | Melamine cyanurate | 0.8 | 50 | B (◯) | B (◯) |
| Example 8 | Melamine cyanurate | 1 | 50 | B (◯) | B (◯) |
| Example 9 | Melamine cyanurate | 3 | 50 | B (◯) | B (◯) |
| Example 10 | Melamine cyanurate | 10 | 50 | C(Δ) | B (◯) |
| Example 11 | Melamine cyanurate | 14 | 50 | C(Δ) | B (◯) |
| Example 12 | Melamine cyanurate | 2 | 20 | C(Δ) | C(Δ) |
| Comparative | Zinc stearate | 1.5 | 50 | D (X) | C(Δ) |
| Example 1 | | | | | |
| Comparative | Boron nitride | 0.5 | 50 | D (X) | D (X) |
| Example 2 | | | | | |

From the above results, it can be seen that the intermediate transfer belts of Examples have improved the transfer maintenance property and the cleaning maintenance property as compared with the intermediate transfer belts of Comparative Examples.

### Examples 101 to 104

Melamine cyanurate “MC6000” (manufactured by Nissan Chemical Industries, Ltd.) as a solid lubricant was compression-molded to obtain a plate-shaped molded body.

A solid lubricant supply device that supplies a solid lubricant to an intermediate transfer belt by scraping the plate-shaped molded body with a rotary brush was produced.

The transfer maintenance property and the cleaning maintenance property were evaluated using a modified machine of an image forming apparatus “Versant 180 press” (manufactured by FUJIFILM Business Innovation Corp.) equipped with the solid lubricant supply device.

However, the supply amount of the solid lubricant supplied from the solid lubricant supply device was set to an amount corresponding to each of the coverages of the coating bodies of the solid lubricants shown in Table 2.

### Comparative Examples 101 to 103

The transfer maintenance property and the cleaning maintenance property were evaluated in the same manner as in Example 101, except that zinc stearate (manufactured by FUJIFILM Wako Pure Chemical Corporation) was used as the solid lubricant.

TABLE 2

| | | Coverage of | | |
|---|---|---|---|---|
| | | coating body of | Evaluation | |
| | Solid lubricant | solid lubricant | Transfer maintenance | Cleaning maintenance |
| | Type | (%) | property | property |
| Example 101 | Melamine cyanurate | 50 | A + (⊙+) | B (◯) |
| Example 102 | Melamine cyanurate | 10 | A (⊙) | B (◯) |
| Example 103 | Melamine cyanurate | 30 | A (⊙) | B (◯) |
| Example 104 | Melamine cyanurate | 90 | A (⊙) | B (◯) |
| Comparative | Zinc stearate | 10 | D (X) | D (X) |
| Example 101 | | | | |
| Comparative | Zinc stearate | 50 | D (X) | C(Δ) |
| Example 102 | | | | |
| Comparative | Zinc stearate | 90 | D (X) | C(Δ) |
| Example 103 | | | | |

From the above results, it is found that the Examples have improved the transfer maintenance property and the cleaning maintenance property as compared with the Comparative Examples.

What is claimed is:

1. An intermediate transfer belt comprising, on an outer peripheral surface, a coating body of a solid lubricant selected from an organic layered compound or an organic-inorganic composite layered compound.

2. The intermediate transfer belt according to claim 1, wherein the solid lubricant is an organic layered compound.

3. The intermediate transfer belt according to claim 2, wherein the organic layered compound is melamine cyanurate.

4. The intermediate transfer belt according to claim 1, wherein the solid lubricant has an average particle diameter of 1.0 μm or more and 15.0 μm or less.

5. The intermediate transfer belt according to claim 4, wherein the average particle diameter of the solid lubricant is 2.0 m or more and 5.0 m or less.

6. The intermediate transfer belt according to claim 1, wherein the coating body has a coverage of 30% or more.

7. The intermediate transfer belt according to claim 6, wherein the coverage of the coating body is 40% or more.

8. A transfer device comprising:
an intermediate transfer belt having an outer peripheral surface onto which a toner image is transferred, the intermediate transfer belt according to claim 1;
a primary transfer device including a primary transfer member that primarily transfers a toner image formed on a surface of an image holding body onto the outer peripheral surface of the intermediate transfer belt;
a secondary transfer device including a secondary transfer member that is disposed in contact with the outer peripheral surface of the intermediate transfer belt and secondarily transfers the toner image transferred onto the outer peripheral surface of the intermediate transfer belt onto a surface of a recording medium; and
a cleaning device including a cleaning member that cleans the outer peripheral surface of the intermediate transfer belt.

9. An image forming apparatus comprising:
a toner image forming device that includes an image holding body and forms a toner image on a surface of the image holding body; and
a transfer device that transfers the toner image formed on the surface of the image holding body onto a surface of a recording medium, the transfer device according to claim 8.

10. A transfer device comprising:
an intermediate transfer belt having an outer peripheral surface onto which a toner image is transferred;
a primary transfer device including a primary transfer member that primarily transfers a toner image formed on a surface of an image holding body onto the outer peripheral surface of the intermediate transfer belt;
a secondary transfer device including a secondary transfer member that is disposed in contact with the outer peripheral surface of the intermediate transfer belt and secondarily transfers the toner image transferred onto the outer peripheral surface of the intermediate transfer belt onto a surface of a recording medium;
a cleaning device including a cleaning member that cleans the outer peripheral surface of the intermediate transfer belt; and
a solid lubricant supply device that supplies a solid lubricant selected from an organic layered compound or an organic-inorganic composite layered compound to the outer peripheral surface of the intermediate transfer belt.

11. The transfer device according to claim 10, wherein the solid lubricant is an organic layered compound.

12. The transfer device according to claim 11, wherein the organic layered compound is melamine cyanurate.

13. The transfer device according to claim 10, wherein the solid lubricant has an average particle diameter of 1.0 m or more and 15.0 m or less.

14. The transfer device according to claim 13, wherein the average particle diameter of the solid lubricant is 2.0 m or more and 5.0 m or less.

15. The transfer device according to claim 10, wherein the solid lubricant supply device supplies the solid lubricant to the outer peripheral surface of the intermediate transfer belt in an amount such that a coverage of a coating body of the solid lubricant is 30% or more.

16. The transfer device according to claim 15, wherein the solid lubricant supply device supplies the solid lubricant to the outer peripheral surface of the intermediate transfer belt in an amount such that the coverage of the coating body of the solid lubricant is 40% or more.

17. An image forming apparatus comprising:
a toner image forming device that includes an image holding body and forms a toner image on a surface of the image holding body; and
a transfer device that transfers the toner image formed on the surface of the image holding body onto a surface of a recording medium, the transfer device according to claim 10.
